(19) United States
(12) Patent Application Publication
(10) Pub. No.: US 2012/0329642 A1
(43) Pub. Date: Dec. 27, 2012

(54) PLATINUM-PALLADIUM CATALYST WITH INTERMEDIATE LAYER

(75) Inventor: Minhua Shao, Manchester, CT (US)

(73) Assignee: UTC Power Corporation, South Windsor, CT (US)

(21) Appl. No.: 13/497,605

(22) PCT Filed: Dec. 28, 2009
(86) PCT No.: PCT/US09/69562

§ 371 Date: Mar. 22, 2012

(51) Int. Cl. B01J 23/44; B01J 23/52; B01J 27/22

(52) U.S. Cl. 502/177; 502/339; 502/185; 502/330

(57) ABSTRACT

A fuel cell catalyst comprises a support having a core arranged on the support. In one example, the core includes palladium nanoparticles. A layer, which is gold in one example, is arranged on the core. A platinum overlayer is arranged on the gold layer. The intermediate gold layer greatly increases the mass activity of the platinum compared to catalysts in which platinum is deposited directly onto the palladium without any intermediate gold layer.

### BACKGROUND

This disclosure relates to a stable, high activity platinum catalyst for use in a fuel cell or other catalyst applications.

Fuel cells are commonly used for generating electric current. For example, a single fuel cell typically includes an anode catalyst, a cathode catalyst and an electrolyte between the anode and cathode catalysts for generating electric current in a known electrode chemical reaction between a reactant and an oxidant.

One issue encountered with fuel cells is the operational efficiency of the catalyst. For example, electrochemical activity at the cathode catalyst is one parameter that controls the efficiency. An indication of the electrochemical activity is the rate of electrochemical reaction of the oxidant at the cathode catalyst. Platinum has been used as a cathode catalyst. However, platinum is expensive and has sluggish kinetics of oxygen reduction reaction, which hinders the commercialization of low temperature fuel cells.

### SUMMARY

A fuel cell catalyst is disclosed that includes a support having a catalyst core arranged on the support. In one example, the core includes palladium. A layer, which is gold in one example, is arranged on the core. A platinum overlayer is arranged on the gold layer. The intermediate gold layer greatly increases the mass activity of the platinum compared to catalysts in which platinum is deposited directly onto the palladium without any intermediate gold layer.

A method of manufacturing the above fuel cell catalyst may include depositing a copper layer onto the palladium core to facilitate later deposition of the gold layer. In one example, a copper monolayer is replaced with a gold submonolayer by the reaction between Au³⁺ and Cu.

Another method of manufacturing the above fuel cell catalyst may include depositing an Au layer onto the palladium core by the reaction between Au³⁺ and Pd.

### BRIEF DESCRIPTION OF THE DRAWINGS

The disclosure can be further understood by reference to the following detailed description when considered in connection with the accompanying drawings wherein:

FIG. 1 is an example catalyst according to one aspect of the disclosure.

FIGS. 2A-2E depict the steps of an example manufacturing method to produce the catalyst illustrated in FIG. 1.

FIGS. 3A-3D depict the steps of another example manufacturing method to produce the catalyst illustrated in FIG. 1.

### DETAILED DESCRIPTION

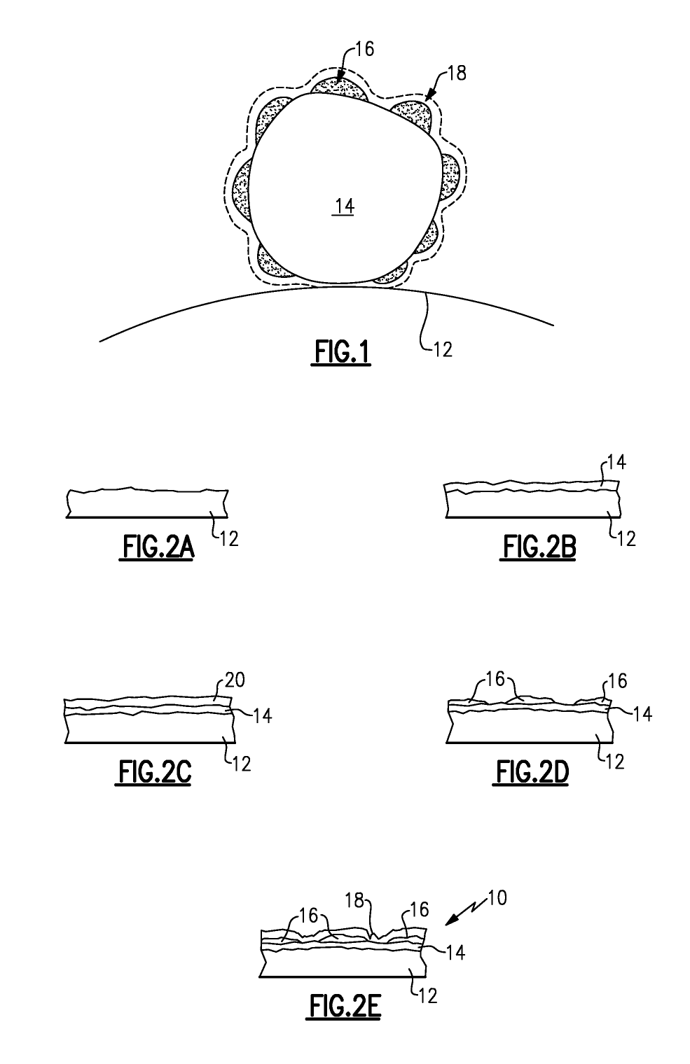

An example catalyst 10 according to one aspect of the disclosure is illustrated in FIG. 1. The catalyst 10 includes a support 12, which may be constructed from carbon black, carbides, oxides, boron doped diamond, and combinations thereof. A catalyst core or layer 14 of palladium nanoparticles is deposited onto the support 12. It should be understood that the catalyst core or layer need not be a continuous layer or film leaving portions of the support exposed. The palladium layer 14 includes palladium particles, which may be palladium alloy particles, for example. An example palladium alloy is palladium alloyed with one or more transition metals.

The catalyst 10 includes an outer or overlayer 18 of platinum, which includes at least one of a monolayer, bilayer or trilayer. The overlayer will normally be comprised of zerovalent platinum atoms. Rather than depositing platinum directly onto the palladium layer 14 without any intermediate material or layer, an intermediate layer 16 is provided between the palladium layer 14 and platinum overlayer 18. In one example, a transition metal is deposited onto the palladium layer 14. For example, the transition metal is gold.

In one example, the intermediate layer 16 is a submonolayer of gold. That is, the gold submonolayer does not completely cover the palladium layer 14. In one example, the palladium layer 14 has approximately 5-80% of its surface covered with gold. In another example, the palladium layer 14 has approximately 20-70% of its surface covered with gold. For example, the palladium layer 14 has approximately two thirds of its surface covered with gold. An overlayer of platinum is deposited onto the gold submonolayer, as illustrated in FIG. 1. It should be noted that some of the platinum may be deposited onto the exposed palladium layer 14. This intermediate submonolayer of gold increases the platinum mass activity from approximately 0.7 A/mg (for a catalyst with no intermediate layer) to approximately 1.18 A/mg. The gold submonolayer deposition may be controlled by the exposure time of the palladium-based particles to a gold solution, the concentration of the gold solution, and the total amount of gold in the solution.

Another example manufacturing method to produce the catalyst 10 is illustrated in FIGS. 2A-2E. A support 12 is provided, as illustrated in FIG. 2A. Palladium nanoparticles are deposited onto the support 12 to provide a palladium layer 14 (FIG. 2B). A copper monolayer 20 is deposited onto the palladium core 14 using an under-potential deposition method (FIG. 2C). In one example, the copper monolayer 20 includes copper metallic atoms. A gold submonolayer is deposited onto the palladium layer 14 in a standard oxidation reduction reaction: Cu+2/3Au³⁺→2/3Au+Cu²⁺. The result is illustrated in FIG. 2D. As a result of the reaction, about two thirds of the surface of the palladium layer 14 is covered in gold. A platinum layer 18 is deposited onto the gold submonolayer 16, as illustrated in FIG. 2E. The amount of copper deposited on palladium can be controlled by the deposition potential. Thus, the coverage of Au on palladium can be lower than two thirds by controlling the coverage of Cu.

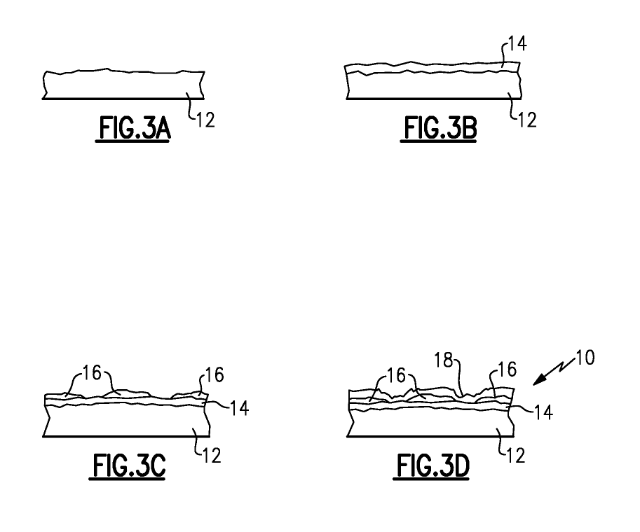

Another example manufacturing method to produce the catalyst 10 is illustrated in FIGS. 3A-3D. A support 12 is provided, as illustrated in FIG. 3A. Palladium nanoparticles are deposited onto the support 12 to provide a palladium layer 14 (FIG. 3B). A gold submonolayer can be deposited onto the palladium layer 14 by directly mixing the palladium particles in a solution containing gold salts. Some palladium atoms are replaced with gold in a standard oxidation reduction reaction: Pd+2/3Au³⁺→2/3Au+Pd²⁺. The result of which is illustrated in FIG. 3C. As a result of the reaction, a portion of the surface of the palladium layer 14 is covered in gold. The gold submonolayer deposition may be controlled by the exposure time of the palladium-based particles to a gold solution, the concentration of the gold solution, and the total amount of the gold in the solution. A platinum layer 18 is deposited onto the gold submonolayer 16, as illustrated in FIG. 3D. In this method, small gold clusters may be formed rather than a smooth gold submonolayer. If a palladium layer 14 is palladium alloy, the transition metal atoms on the alloy surface may react with gold salts to form metallic gold atoms deposited on palladium surface.

Although an example embodiment has been disclosed, a worker of ordinary skill in this art would recognize that certain modifications would come within the scope of the claims. For that reason, the following claims should be studied to determine their true scope and content.

What is claimed is:

1. A fuel cell catalyst comprising:
a support;
a catalyst core deposited on the support, the catalyst core including palladium;
a layer arranged on the catalyst core, the layer including a transition metal; and
a platinum overlayer arranged on the layer.

2. The fuel cell catalyst according to claim 1, wherein the support is at least one of carbon black, carbides, oxides, boron doped diamond, and combinations thereof.

3. The fuel cell catalyst according to claim 1, wherein the transition metal is gold.

4. The fuel cell catalyst according to claim 1, wherein the layer is a submonolayer of gold.

5. The fuel cell catalyst according to claim 4, wherein the gold covers approximately 5-80% of the palladium core.

6. Fuel cell catalyst according to claim 5, wherein the gold covers approximately 20-70% of the palladium core.

7. The fuel cell catalyst according to claim 1, wherein the platinum overlayer is at least one of monolayer, bilayer, and trilayer.

8. The fuel cell catalyst according to claim 7, wherein the platinum overlayer is zerovalent platinum atoms.

9. The fuel cell catalyst according to claim 1, wherein the catalyst core is palladium alloy nanoparticles alloyed with one or more transition metals.

10. The fuel cell catalyst according to claim 1, wherein the core palladium is comprised of palladium nanoparticles.

11. A method of manufacturing a fuel cell catalyst comprising:
providing a support;
depositing a catalyst core containing palladium onto the support;
depositing a layer containing a transition metal onto the catalyst core; and
depositing an overlayer containing platinum atoms onto the layer.

12. The method according to claim 11, wherein the support includes at least one of carbon black, carbides, oxides, boron doped diamond, and combinations thereof.

13. The method according to claim 11, wherein the catalyst core depositing step includes depositing nanoparticles of palladium onto the support.

14. The method according to claim 11, wherein the catalyst core includes palladium nanoparticles.

15. The method according to claim 14, wherein the catalyst core is palladium alloy nanoparticles alloyed with one or more transition metals.

16. The method according to claim 11, wherein the layer of transition metal is arranged between the catalyst core and the platinum overlayer.

17. The method according to claim 11, wherein the platinum overlayer is at least one of monolayer, bilayer, and trilayer of zerovalent platinum atoms.

18. The method according to claim 17, wherein the transition metal layer depositing step provides a transition metal submonolayer.

19. The method according to claim 18, wherein the transition metal is gold.

20. The method according to claim 19, wherein the transition metal depositing step includes depositing a copper monolayer onto the catalyst core.

21. The method according to claim 20, wherein the transition metal depositing step includes replacing the copper monolayer with a gold submonolayer.

22. The method according to claim 19, wherein the gold covers 5-80% of the catalyst core.

23. The method according to claim 22, wherein the gold covers 20-70% of the catalyst core.

24. The method according to claim 23, wherein the gold covers approximately two-thirds of the catalyst core.

25. The method according to claim 11, wherein the layer depositing step includes exposing the catalyst core containing palladium nanoparticles to a solution containing gold salt, and including depositing gold onto the catalyst core.
